(19) United States
(12) Patent Application Publication
(10) Pub. No.: US 2009/0280386 A1
(43) Pub. Date: Nov. 12, 2009

(54) METALLIC BIPOLAR PLATE FOR FUEL CELL

(75) Inventors: Volker Buck, Velbert (DE); Angelika Heinzel, Duisburg (DE)

Correspondence Address: Jason H. Vick;Sheridan Ross, PC, Suite # 1200, 1560 Broadway, Denver, CO, 80202, US

(73) Assignee: UNIVERSITAT DUISBURG-ESSEN, Essen (DE)

(21) Appl. No.: 12/118,415

(22) Filed: May 9, 2008

(51) Int. Cl. H01M 2/00; B05D 5/12

(52) U.S. Cl. 429/34; 427/115

(57) ABSTRACT

Proposed are a bipolar plate for a fuel cell and a method for the manufacture thereof. A simple, cost-effective manufacture is achieved with particularly good characteristics (high electrical conductance, high resistance to corrosion) by coating metallic plate material with Ti₃SiC₂ and subsequently forming it.

The present invention relates to a metallic bipolar plate for a fuel cell as well as to a method for the manufacture of a metallic bipolar plate.

Fuel cell arrangements generally consist of a plurality of serially connected individual fuel cells. The electrical contacting of the anode and the cathode of adjacent fuel cells takes place respectively via a so-called bipolar plate. Moreover, the feeding of the reaction gases and the removal of the reaction products usually occur via a structured surface of the bipolar plate. The bipolar plate is sometimes also referred to as the cell frame.

The bipolar plate must meet a wide variety of requirements. A low electrical resistance and a high resistance to corrosion are important characteristics. In order to achieve a technically usable voltage, the fuel cells are “stacked,” i.e. fuel cell stacks are formed or the individual cells are connected serially. As a result, all of the resistances of the individual cells are added up and contribute to ohmic losses of the fuel cell stack under current flow. It is therefore of corresponding importance to minimize the electrical resistances of the fuel cells. Accordingly, the materials used must at least be good electrical conductors. Graphitic or metallic materials are preferably used.

Bipolar plates made of metal have major advantages for reasons related to manufacturing and costs. With metals, however, not only the electrical resistances but also the problem of corrosion must be taken into account. While there are reductive conditions on one side of the bipolar plate, there are oxidizing conditions on the other side. Moreover, potentials of up to 1.2 volts occur. As a product of the fuel cell reaction, pure water is problematic even for stainless steels, particularly at the typically elevated operating temperatures.

In view of the aforementioned requirements, metallic bipolar plates can be provided with a coating in order to achieve the objectives (low resistance, high corrosion stability) at low cost.

Another aspect is the manufacturing technique. Metallic bipolar plates are manufactured through the forming of sheet metal. Up to now, the forming process for producing the desired structured surfaces (particularly for conducting gas in the fuel cell) must occur prior to the subsequent coating, since today's coatings are not able to survive such forming processes unscathed.

WO 01/78175 A1 discloses a metallic bipolar plate with a low-ohmic coating. The coating is designed to be polyphase at least in the area of its contacting outer surface, with the coating having a metallic phase and a compound phase.

WO 2004/049485 A1 discloses a metallic bipolar plate with a metallic coating, with metallic powder particles being introduced at high speed into the boundary region of the metal material of the bipolar plate for metallurgic bonding with the coating.

The metallic bipolar plates known from the prior art do not have optimal characteristics (low resistance and/or high resistance to corrosion), are laborious to manufacture and/or are expensive.

Ternary ceramics and new carbide and nitride materials are known, for example, from the article, “The MAX Phases: Unique New Carbide and Nitride Materials” by Michael W. Barsoum et al., which appeared in “American Scientist,” Volume 89, 2001, pages 334 to 343. Up to now, the use of these materials has essentially only been taken into consideration for engineering and electrical contacts, particularly to minimize wear, but not for bipolar plates in fuel cells, even though various outstanding characteristics of these materials such as high resistance to oxidation, low contact resistance or the like are already known.

It is the object of the present invention to propose a metallic bipolar plate and method for the manufacture thereof, wherein the desired characteristics, particularly a low electrical resistance together with a high resistance to corrosion, simplified manufacture and/or cost-effective manufacture are made possible.

The above object is achieved through a metallic bipolar plate according to claim 1, a fuel cell according to claim 9 or a method according to claim 11. Advantageous modifications are the object of the dependent claims.

A primary aspect of the present invention consists in that the coating of the bipolar plate consists of Mₙ₊₁HXₙ, where M is a transition metal, H is selected from Cd, Al, Ga, In, Tl, Si, Ge, Dn, Pb, P, As and S, and X is selected from carbon and nitrogen and where n=1, 2 or 3. Preferably, M is selected from Sc, Ti, Zr, Hf, V, Nb, Ta, Cr and Mo. Especially preferably, the coating consists at least substantially of Ti₃SiC₂.

The proposed coating possesses a high electrical conductance (roughly that of gold) and a good resistance to corrosion. What is more, the coating can be manufactured cost-effectively. Particularly, it is possible to apply the coating through high-current pulse sputtering or through CVD (Chemical Vapor Deposition). Alternatively, an electrochemical deposition of the coating is possible.

The coating is preferably free from phase shift, single-layered, nanostructured, flexible, (relatively) soft and/or (extremely) dense.

The proposed coating is preferably applied to the bipolar plate or its plate material, preferably sheet metal, prior to forming. The coated plate material is then formed to produce the bipolar plate in the desired manner, for example through pressing, deep-drawing or the like. This permits an especially simple and hence also cost-effective manufacture, since the individual bipolar plates need not be coated any longer after forming.

Particularly, another aspect of the present invention which can even be implemented independently consists in first providing the bipolar plate—more precisely, the metallic plate material of the bipolar plate—with a nanostructured and inorganic coating and only then forming it to produce or manufacture the bipolar plate. A simple and cost-effective manufacture is thus made possible.

Other aspects, features, characteristics and advantages of the present invention follow from the claims and the following description of a preferred embodiment on the basis of the drawing.

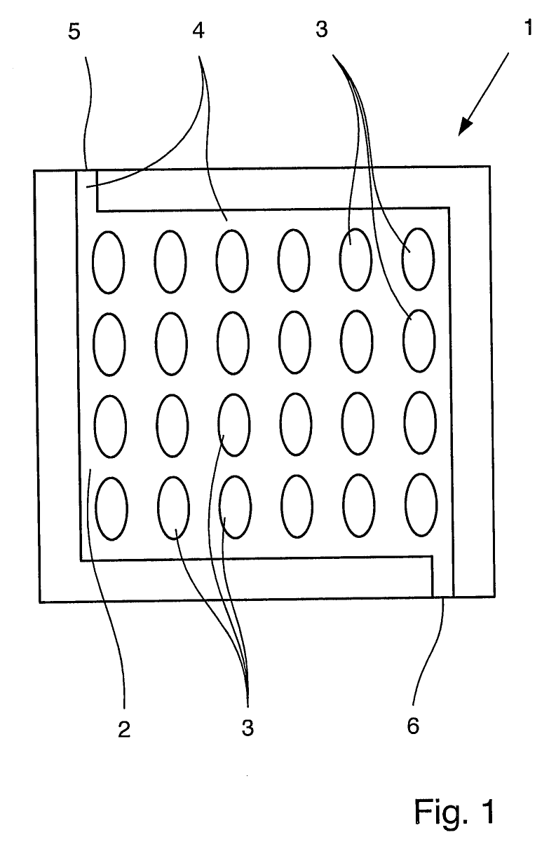

FIG. 1 shows a schematic representation of a proposed bipolar plate;

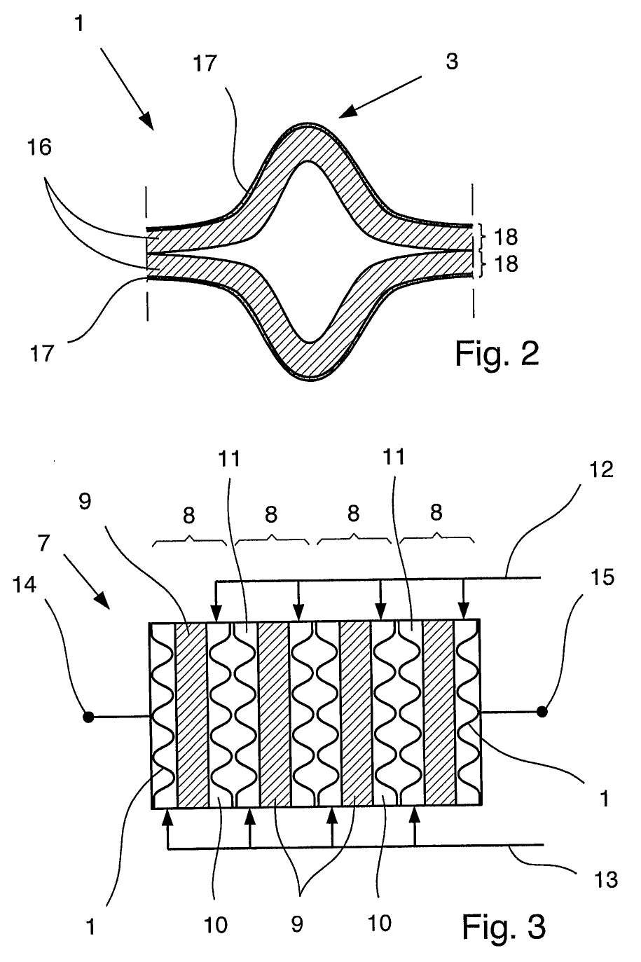

FIG. 2 shows a partial schematic section of the proposed bipolar plate; and

FIG. 3 shows a schematic representation of a fuel cell arrangement with proposed bipolar plates.

FIG. 1 shows, in very schematic representation, a proposed bipolar plate 1. The bipolar plate 1 has a surface 2 which is structured at least in areas, particularly with high spots 3 and/or recesses or channels 4 or the like. This structuring serves, in particular, to conduct gas in a fuel cell. For example, fuel gas or oxidation gas can flow from an inlet 5 via a so-called flow field to an outlet 6.

FIG. 2 shows, in partial schematic section, a portion of the proposed bipolar plate 1 in the area of a high spot 3.

FIG. 3 shows, in schematic section not true to scale, a fuel cell arrangement 7 with several fuel cells 8 arranged in a stack or connected serially, each of which has a proposed bipolar plate 1 as a cell frame or for the purpose of the separation or the formation of cathode or anode. Moreover, the fuel cells 8 each preferably have a membrane 9 or the like, particularly to separate gas chambers 10, 11 of the respective fuel cell 8.

The gas chambers 10, 11 are only indicated schematically in FIG. 2 and, particularly, are formed or delimited by the bipolar plate 1—particularly by the surface structure.

Additionally indicated in FIG. 3 are schematic feeds 12 and 13 for fuel or gas, particularly fuel gas and oxidation gas.

During operation, the fuel cell arrangement 7 emits electrical energy via connections 14 and 15. Alternatively or in addition, however, the individual bipolar plates 1 can also be contacted via electrical connections (not shown) and/or—particularly in the case of fuel cells 8 which are separated from each other—connected to each other.

The bipolar plate 1 is preferably manufactured or constructed from a metallic plate material 16 and provided with a coating 17 as shown in FIG. 2. Especially preferably, a half-plate 18 is formed therefrom which is particularly constructed into a bipolar plate 1 from a corresponding, opposing or complementary half-plate 18. However, a half-plate 18 can also form a bipolar plate 1 in and of itself. As needed, the half-plates 18 can also be provided with the coating 17 on both sides.

In particular, the plate material 16 is a sheet metal, preferably of steel, stainless steel, titanium or the like.

A provision is made that the coating 17 consists of Mₙ₊₁HXₙ, where M is a transition metal, H is selected from Cd, Al, Ga, In, Tl, Si, Ge, Sn, Pb, P, as [sic] and S, and X is selected from carbon and nitrogen and where n=1, 2 or 3. Preferably, M is selected from Sc, Ti, Zr, Hf, V, Nb, Ta, Cr and Mo. Especially preferably, the coating 17 consists at least substantially of Ti₃SiC₂.

The coating 17 consisting of Ti₃SiC₂ has proved to be particularly advantageous. An analysis of the structure of the coating 17 shows a self-organized layer structure (nanostructuring) in which a monoatomic silicon layer alternates with layers of titanium and carbon. Particularly, such a layering or a comparable layering is understood in the present invention as being nanostructured.

Other investigations have shown that the coating 17 has extraordinary chemical, thermal, mechanical and electrical characteristics. Particularly, at ca. 2·10⁻⁷ ohms·m, the electrical resistance is as low as in metals. Moreover, the resistance to oxidation and corrosion is excellent even at high temperatures, particularly as with ceramics. A consequence of the nanostructuring is that mechanical damage—insofar as it occurs at all—remains localized in small areas and/or fissures do not propagate or only do so to a limited extent.

Another advantage of the proposed coating 17 consists in that it has an extremely low porosity and/or high density. Particularly, with the proposed coating 17, a lower porosity can be achieved with a comparable layer thickness or a smaller layer thickness can be achieved with a comparable protective effect in comparison to the layers known from WO 01/78175 A1.

Moreover, it has been shown that the proposed coating is unusually resistant to thermal shocks.

Another advantage of the proposed coating 17 is that it is at least relatively flexible and/or soft.

Especially preferably, the coating 17 is applied prior to the forming of the plate material 16 and subsequently formed together with the plate material 16. This permits an especially simple and cost-effective manufacture.

In principle, however, the coating 17 can also be applied after the forming of the plate material 16, i.e. after the forming of the bipolar plate 2.

The thickness of the coating 17 is preferably 100 nm at most, particularly 50 nm at most.

It should be pointed out that the proposed coating 17 can also be used in other bipolar plates 1 as well as in other metallic, electrically conductive components, particularly of a fuel cell 2. Particularly, the term “bipolar plate” should also be understood in its broad meaning which also includes other metallic, electrically conductive components which are formed or shaped.

1. Metallic bipolar plate for a fuel cell with an electrically conductive coating, wherein the coating consists of Mₙ₊₁HXₙ, where M is a transition metal, H is selected from Cd, Al, Ga, In, Ti, Si, Ge, Sn, Pb, P, As and S, and X is selected from carbon and nitrogen and where n=1, 2 or 3.

2. Bipolar plate as set forth in claim 1, wherein the coating is single-layered.

3. Bipolar plate as set forth in claim 1, wherein the coating is nanostructured.

4. Bipolar plate as set forth in claim 1, wherein the coating is flexible and/or soft.

5. Bipolar plate as set forth in claim 1, wherein the coating is dense.

6. Bipolar plate as set forth in claim 1, wherein the bipolar plate is formed with the applied coating.

7. Bipolar plate as set forth in claim 1, wherein M is selected from Sc, Ti, Zr, Hf, V, Nb, Ta, Cr and Mo.

8. Bipolar plate as set forth in claim 1, wherein the coating consists at least substantially of Ti₃SiC₂.

9. Fuel cell with a metallic bipolar plate made of a metallic plate material which is provided with an electrically conductive coating, with the plate material first being provided with a nanostructured coating and then formed.

10. Fuel cell as set forth in claim 9, wherein the coating consists of Mₙ₊₁HXₙ, where M is a transition metal, H is selected from Cd, Al, Ga, In, TI, Si, Ge, Sn, Pb, P, As and S, and X is selected from carbon and nitrogen and where n=1, 2 or 3.

11. Method for the manufacture of a metallic bipolar plate, wherein a metallic plate material is provided with an electrically conductive, nanostructured and inorganic coating and the plate material is formed after the coating to produce the bipolar plate.

12. Method as set forth in claim 11, wherein the coating is single-layered.

13. Method as set forth in claim 11, wherein the coating is flexible.

14. Method as set forth in claim 11, wherein the coating is soft.

15. Method as set forth in claim 11, wherein the coating is dense.

16. Method as set forth in claim 11, wherein the coating consists of Mₙ₊₁HXₙ, where M is a transition metal, H is selected from Cd, Al, Ga, In, Tl, Si, Ge, Sn, Pb, P, As and S, and X is selected from carbon and nitrogen and where n=1, 2 or 3.

17. Method as set forth in claim 16, wherein M is selected from Sc, Ti, Zr, Hf, V, Nb, Ta, Cr and Mo.

18. Method as set forth in claim 11, wherein the coating consists at least substantially of Ti₃SiC₂.
